(19) United States
(12) Patent Application Publication
(10) Pub. No.: US 2026/0181197 A1
(43) Pub. Date: Jun. 25, 2026

(54) Devices, Systems, and Methods for Interactive Program Guides in Hospitality Environments

(71) Applicant: Sonifi Solutions, Inc., Sioux Falls, SD (US)

(72) Inventors: Eric Aasen, Sioux Falls, SD (US); Joshua H. Pulford, Sioux Falls, SD (US); Shaun Eugene Marko, Oak Park, IL (US)

(73) Assignee: Sonifi Solutions, Inc., Sioux Falls, SD (US)

(21) Appl. No.: 19/427,776

(22) Filed: Dec. 19, 2025

Related U.S. Application Data
(60) Provisional application No. 63/847,888, filed on Jul. 21, 2025.
(60) Provisional application No. 63/737,394, filed on Dec. 20, 2024.

(51) Int. Cl. H04N 21/2381; H04N 21/431; H04N 21/81

(52) U.S. Cl. CPC H04N 21/2381; H04N 21/4316; H04N 21/816

(57) ABSTRACT

A system comprises a processor and memory including instructions, which when executed by the processor, cause the processor to generate, based on a request from a first destination device, first video content based on programming guide data specific to a property comprising a plurality of destination devices connected to a first network, receive second video content from a content provider over a second network different than the first network, combine the first video content and the second video content to yield IPG content that enables simultaneous display of the first video content within a first window on a display and the second video content within a second window on the display, and send the IPG content to the first destination device via the first network.

### FIELD

Example embodiments are generally directed to devices, systems, and methods for interactive program guides, for example, for providing to hospitality environments.

### BACKGROUND

Hospitality environments, such as hotels and hospitals, may be equipped with entertainment options which are common to multiple rooms within the environment and/or common across multiple environments. For example, each room within multiple hotels managed by an operator may be enabled to access audio/video content (e.g., on-demand movies, channels, streaming content) through an interactive program guide (IPG), with at least some content of the IPG, such as channel availability, being common to multiple rooms within a hotel and/or multiple hotels.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 illustrates an example system for generating IPG services according to at least one example embodiment.

FIGS. 2A and 2B illustrate various environments for the system in FIG. 1 where the IPG server is local to the environments according to at least one example embodiment.

FIGS. 3A-3C illustrate various environments for the system in FIG. 1 where the IPG server is remote to the environments (cloud-based) according to at least one example embodiment.

FIG. 4 illustrates an example layout for displayed IPG content according to at least one example embodiment.

FIG. 5 illustrates a method according to at least one example embodiment.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

Additional features and advantages of embodiments of the present disclosure will become more readily apparent from the following description, particularly when taken together with the company drawings.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia GeForce RTX 2000-series processors, Nvidia GeForce RTX 3000-series processors, AMD Radeon RX 5000-series processors, AMD Radeon RX 6000-series processors, or any other graphics processing units), application specific integrated circuits (ASICs), field programmable gate arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

At least one embodiment of the present disclosure relates to systems and methods that enable one or more server-based instantiations of an IPG service that can assemble, render and output IPG content with channel information, advertisements, and the like, while also adding a live feed for a Video In A Window (VIW) display of a currently tuned to broadcast channel or IP stream. The IPG service may combine IPG data and content provider assets and connections to live video streams in an IPG template to create a consistent guide regardless of the primary content provider, customer preference, and/or set top box (STB) and/or TV capability. The server may assemble these components into a multi-layer video image or stream, encode the resulting stream and then encapsulate (e.g., packetize) the video into a streaming format suitable for distribution to one or more end users (e.g., TVs in guestrooms in a hotel). The IPG service may source subscription content, Free To Guest (FTG) content, and/or other video content appropriate for a user’s content selections at a specific customer site. In this way, dedicated IPG content can be provided to individual sites to match each site’s preferences and FTG provider. At the same time, the IPG service can provide the highly desirable VIW IPG feature while meeting hospitality industry content protection requirements.

Some examples described herein relate to a single instantiation of an IPG service, hosted on a local server that can assemble, render and output IPG content while also adding the live feed for the VIW display. In this case, the server may be located at each customer site (e.g., hotel) or not located at the site but dedicated to serving a single site or subset of commonly owned or operated sites. Stated another way, IPG content is generated at and by an on-site or off-site server that is managed by a common entity, such as a common hotel operator, a common hotel brand, etc. The server may host IPG templates appropriate for the content provider and/or property with each template adhering to the look and feel desired by the content provider and/or the property in the same or similar manner described above.

Other examples relate to hosting a plurality of virtual IPG sessions using, for example, a cloud architecture where multiple clients, such as hotel properties, are enabled to access IPGs (e.g., video and/or audio including a menu of channels or other selectable content) hosted on a cloud server. This scenario may involve instantiating a plurality of IPGs in the cloud server or other centrally hosted server that serves multiple properties, which may include hotels from different brands, different hospitals, and/or the like. The cloud server may receive a request for IPG content, triggered by a key press on a remote control by a user of a television or other display device within a property, and interpret the user request for IPG content based on the key pressed by the user and information that identifies the property from which the request was received. The cloud server may then distribute the IPG content to an edge device, such as an edge device at the property, which processes the received IPG content, for example, by converting the received IPG content from the low-latency format in which the IPG content was received into a format compatible with the commercial delivery system at the property. For example, a cloud server, responsive to user request for an IPG via a button press on a remote control of a TV, renders IPG content and distributes the rendered IPG content to the property in a low-latency over-the-top (OTT) format for media devices, such as HLS, MPEG-DASH, CMAF, LL-HLS, WebRTC, SRT, and/or the like. The edge device at the property may convert IPG content received from the cloud server (which is in one of the aforementioned low-latency formats) into a format appropriate for distribution over a network to the TV within the property, such as h.264, MPEG2, and/or the like, while also potentially applying CATV QAM standards, in some instances.

Here, it should be appreciated that the term “IPG content” may refer to audio and/or video content for an interactive programming guide, which may be an interactive menu of selectable channels made available for consumption by users at a property (e.g., a hotel, a hospital, etc.), as well as any additional selectable content (e.g., ad content) to be included with the programming in a VIW display.

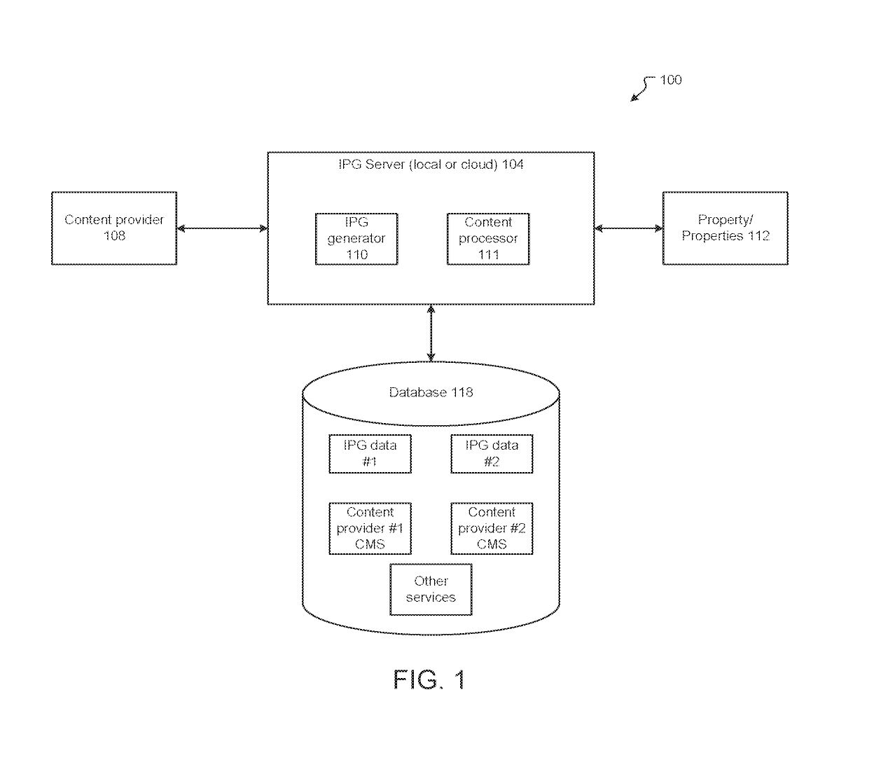

With reference to FIG. 1, a system 100 includes an IPG server 104 (also referred to as server 104) in communication with one or more content providers 108 that provide audio and/or video content for user consumption via TVs at one or more properties 112. Each property 112 may correspond to a hospitality environment such as a hotel, a hospital, and/or another environment having multiple rooms for temporary or permanent occupancy. The system 100 may further include a database 118 storing various types of data accessible by the server 104. The system 100 may further include one or more communication networks (implied by the two-way arrows) which enable wired and/or wireless communication between corresponding communication interfaces of the server 104, the content provider 108, the properties 112, and the database 118. In some examples, the Internet may enable communication between the server 104 and the content provider 108 while each property 112 may include its own communication network, which is under control of the property 112 and/or an entity that manages entertainment for the property 112, for distributing content over wireless and/or wired connections (e.g., Wi-Fi, coaxial cable, Ethernet, and/or the like).

The server 104 may include hardware and software for carrying out computing tasks related to providing interactive content to one or more properties 112, with such interactive content including audio and/or video streams which enable users at each property 112 to select content for viewing (e.g., a linear channel, free to guest (FTG) content, select a subscription streaming service, etc.), view property services (room service, concierge services, etc.), view and select ads, and/or the like, on their guestroom or personal devices. Such guestroom and personal devices may be referred to herein as destination devices, which may include guestroom TVs with or without set top boxes (STBs) or other terminal facilitating content viewing, personal smart phones, personal or guestroom tablets, personal laptops, etc..

As described in more detail herein, the server 104 may be a local server in some examples or a cloud server in other examples. The specific implementation of the server 104 as local or cloud may depend on whether the content provider 108 permits decryption and/or decoding of its sourced content in a cloud environment. If so, then the server 104 may be implemented as a cloud server that provides IPG content for multiple clients, such as different hotel property brands, which are enabled to access their brand-specific IPGs (e.g., video and/or audio including a menu of channels or other selectable content) hosted on a cloud server. This scenario may involve the cloud server 104 hosting a plurality of virtual IPG sessions using, for example, a cloud architecture.

If the content provider 108 does not permit decryption and/or decoding of its content in a cloud environment, then the server 104 may be implemented as a local server that enables a single instantiation of an IPG service which can assemble, render and output IPG content for a particular property or subset of properties managed by a common entity, such as a common hotel operator, a common hotel brand, etc. Notably, a local server for a property need not be located on or at the property and may be located remotely from the property but dedicated to serving that property with at least some security assurances for the content provider 108 (e.g., the server is operated by an entity that manages the overall content distribution system for the property 112).

Still with reference to FIG. 1, the server 104 may comprise an IPG generator 110 and a content processor 111 which cooperate together to generate IPG content to be distributed to destination devices at a property 112, where destination devices may include a smart TV (IPTV), a combination STB/TV, a combination TV/terminal (B-LAN terminal), an in-room tablet, a personal electronic device (smartphone, laptop, tablet), and/or the like. In more detail, the IPG generator 110 may include hardware and software to generate audio and/or video content based on data in the database 118. Meanwhile, the content processor 111 includes hardware and software to receive the audio and/or video content from content provider 108 and combine this content with the programming and ad content output from the IPG generator 110 to yield the IPG content that is distributed to TVs at a property 112. The IPG generator 110 and content processor 111 are described in more detail below with reference to the figures.

The database 118 may include one or more electronic memory devices (a random access memory (RAM) device, flash memory, hard disk drive, solid state drive, etc.) for storing information from sources of IPG data, information from content management systems (CMSs) of content providers 108, and information from other parties about other services. By way of non-limiting example, the blocks labeled IPG DATA 1 and IPG DATA 2 may correspond to sources of data that indicate what type of data to include in IPG content for a particular property 112. For example, each IPG DATA block 1 and 2 may be associated with a different property 112, and each IPG DATA block may contain property-specific information that should be included in IPG content sent to that property. Property-specific information may include graphical content that a property 112 wants its occupant users to view, such as hotel brand, color scheme for the hotel brand, services available at the property 112 (e.g., room-service information, concierge services, activity scheduling, etc.), and/or the like. Each IPG DATA block may also include content provider-specific programming data to provide program descriptions and timing information to populate a programming guide grid for presentation to the user. Each IPG DATA block may be updateable by an operator of a property 112 to give the operators of properties 112 control over the look and feel of the IPG content generated for the occupants of each property 112.

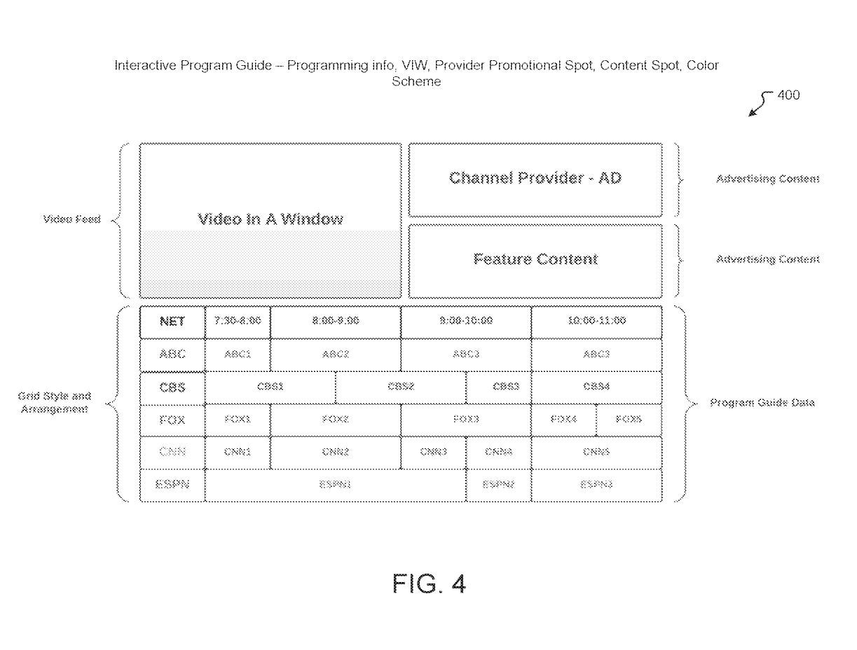

The illustrated blocks labeled Content provider CMS 1 and 2 may be sources of information controlled by a respective content provider 108. For example, in the same/similar way that each property 112 has control over the look and feel of certain elements within IPG content, each content provider CMS block 1, 2 may provide the content providers 108 with the same or similar control over the look and feel of other elements of IPG content. For example, DIRECTV may correspond to Content provider 1 CMS and may control the look and feel of the IPG content (e.g., the programming guide in FIG. 4) generated for properties 112 that subscribe to DIRECTV services while another content provider may correspond to Content provider 2 CMS. Controlling the look and feel may include controlling the graphical presentation of channels and/or other available content provided by DIRECTV and the other provider in the same or similar manner as the IPG DATA.

The illustrated block labeled Other Services may include sources of information controlled by an operator of the server 104. For example, the operator of the server 104 may have the ability to control the look and feel of certain elements of IPG content to, for example, provide operator brand information included with the IPG content (e.g., the company name of the operator), third-party advertisements in the IPG content, additional services provided by the operator of the server 104 (e.g., a graphic informing a user that other elements in a room, such as lighting, window shades, etc. may be controlled with the operator’s software), and/or the like.

As may be appreciated, the amount of and types of data stored in the database 118 and whether the database 118 is local to or remote from the server 104 may depend on whether the server 104 serves one property 112 or multiple properties 112. In any event, each property 112 and/or each content provider 108 may be granted access privileges, via different usernames and passwords or other authentication method, to modify its data in the database 118.

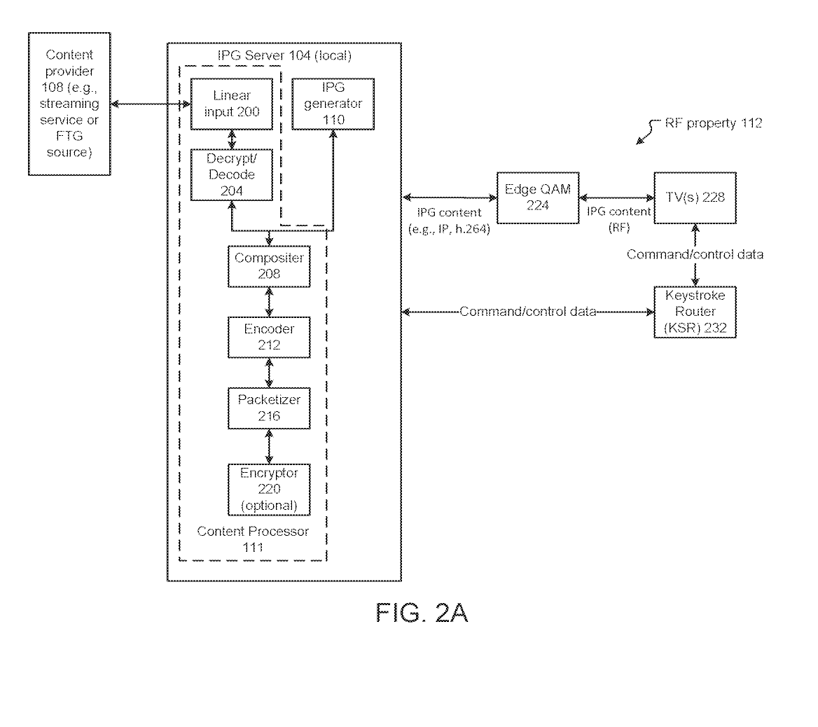

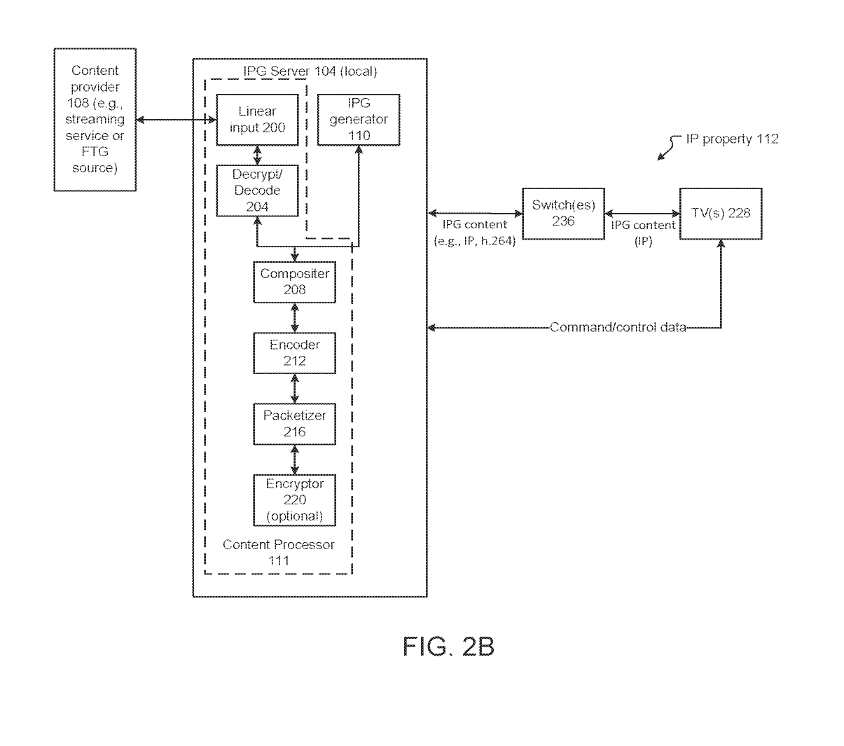

FIGS. 2A and 2B illustrate various environments for the system in FIG. 1 where the IPG server 104 is a local server that provides IPG content for a single property 112 or a subset of commonly owned or commonly managed properties 112.

In more detail, FIG. 2A illustrates distribution of the IPG content over a radio frequency (RF) network to TV(s) 228 of a property 112. Unlike the network which connects the content provider 108 and the server 104 that is external to the property 112, the RF network may be internal to the property 112 and managed by an operator of the server 104 and/or the property itself. The RF network internal to the property 112 may include a format converter, such as an edge quadrature amplitude modulation (QAM) device 224, for converting the IP signal of IPG content output from the server 104 into an RF signal for distribution to one or more TVs 228.

In addition, command and control data resulting from user inputs to a TV or remote control of a TV and passed between the TV and the server 104 may be interpreted by a command router, such as a keystroke router (KSR) 232 to interpret and route commands and control signals corresponding to the commands between the TVs 312 and the server 104. Commands from the TV or remote control of the TV are interpreted by the KSR 232 and passed to the server 104 in a format and with information that the server 104 can use to process the command, which may involve controlling content from the content provider 108 (pause, play, forward, rewind), retrieving content associated with an ad selected in the IPG content, and/or the like. The server 104 may send control signals corresponding to the command to the KSR 232 that processes the control signals to cause a function which corresponds to the command to occur at the requesting TV 228. The KSR 232 is shown as being part of the RF network internal to the property 112 but may also be external to the property 112, for example, if the KSR 232 is integrated with a server 104 that happens to be remote to the property 112.

Meanwhile, FIG. 2B illustrates distribution of the IPG content over an IP network of the property 112 to the TVs 228. Like the RF network of FIG. 2A, the IP network of the property 112, including switches 226 and TV(s) 228, may be internal to the property 112 while the network which connects the content provider 108 and the server 104 is external to the property 112. The switches 236 may correspond to Ethernet switches and/or other suitable components for routing IP traffic to TVs 228. Although not explicitly shown, the TVs 228 may be IPTVs (e.g., smart TVs), connected to a STB that handles IP traffic, or otherwise be capable to displaying an IP signal having the IPG content and transmitting and processing command/control data which includes user commands at the TV 228 and control signals which correspond to the user commands.

As alluded to above, the IPG generator 110 may generate part of the IPG content output from the server 104 based on information from the database 118. For example, the IPG generator 110 may store and select from a plurality of templates that have different presentation layouts for the different types of information in the database 118 to be included in the IPG content. The IPG template and corresponding content from the IPG generator 110 may be customized for the particular property, the particular content provider, the particular user, the operator of the server, or any combination thereof. FIG. 4 illustrates one example an IPG template for IPG content displayed at a user’s TV, where the template selected by the generator 110 has the live feed from the content provider 108 in a VIW at the upper left corner of the display and information from the database 118 including a programming guide, ads from a channel provider, and featured content in other areas of the display. The IPG content may be interactive in that a user can use their TV remote control to navigate the windows in FIG. 4 to select informational icons (e.g., feature content, such as room service details), select ad icons (which triggers the server 104 to transition the VIW feed to an image or video associated with the ad), select channel icons in the programming guide, navigate forward and backward in time in the programming guide, etc.

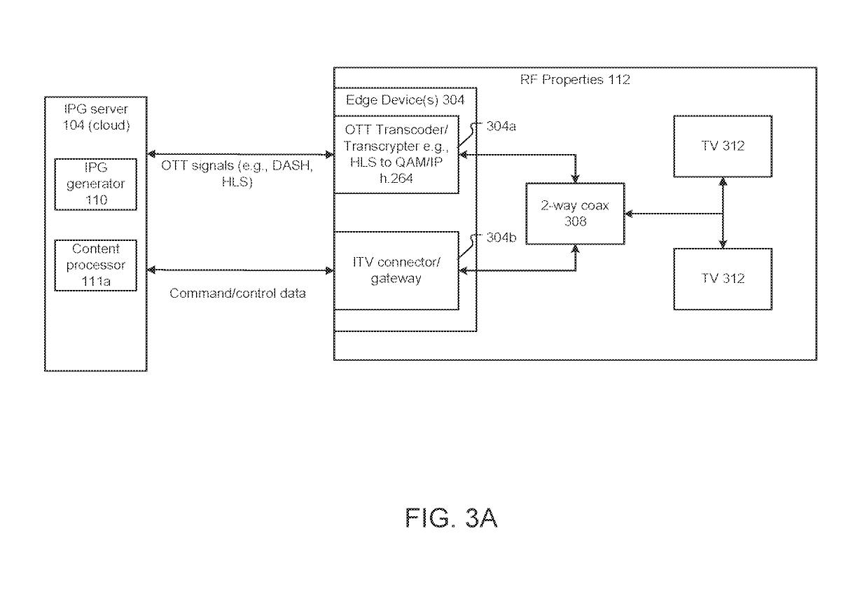

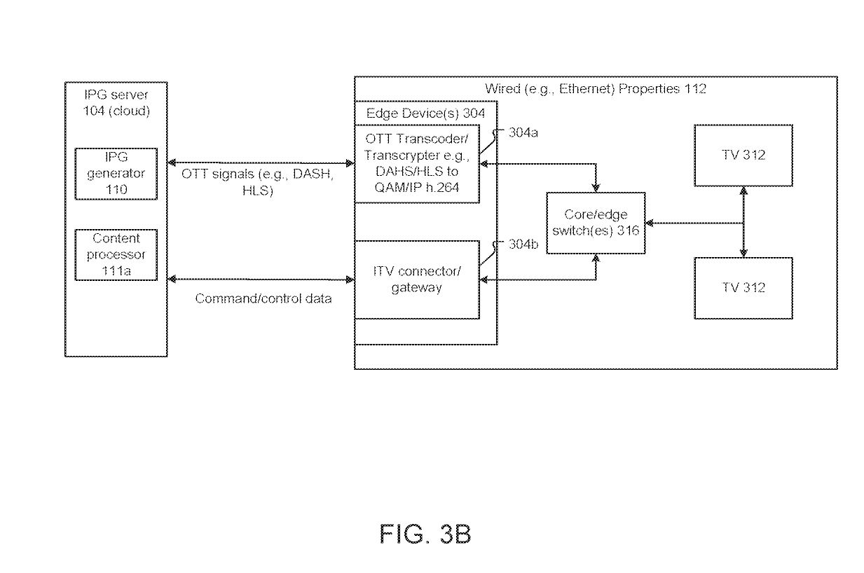

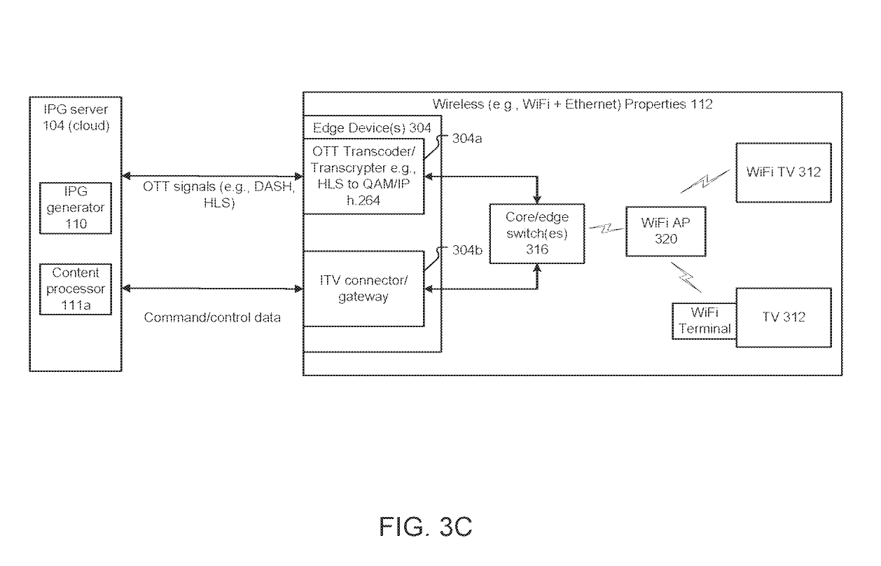

Although not explicitly shown, it should be appreciated that FIGS. 2A and/or 2B may implement at least part of the internal network of the property with Wi-Fi access points to facilitate communication of at least some of the command/control data, as shown in FIG. 3C for example.

As may be appreciated from FIGS. 2A and 2B, output of the IPG generator 110 is processed by the content processor 111, which includes a linear input 200 for receiving content from the content provider 108, a decrypter/decoder for decrypting and decoding the received content, a compositer 208 for combining output of the decrypter/decoder 204 with output of the IPG generator 110, an encoder 212 to encode the combined content using a standard or protocol suitable for distributing IPG content at the property 112, a packetizer 216 for encapsulating (packetizing) the IPG content, and an optional encryptor 220 for encrypting the encapsulated IPG content.

The linear input 200 may include a communication interface suitable for receiving streaming content from the content provider 108 and performing suitable preprocessing operations to prepare the content for the decrypt/decode circuitry 204. The decrypt/decode circuitry 204 may include hardware and software for removing encryption and encoding from the content received by input 200 to output a raw content signal which is able to be manipulated (e.g., resized and formatted to fit with output of the IPG generator 110) by the compositer 208. The content provider 108 may provide content to server 104 using a low latency streaming standard such as HLS, MPEG-DASH, CMAF, LL-HLS, WebRTC, SRT, etc. and thus, the decrypter/decoder 204 may include suitable hardware and software for removing encryption and encoding normally used for those standards.

The compositer 208 may include an html video combiner or other suitable type of video combiner and picture resizer/relocator that combines the content from content provider 108 with content from IPG generator 110. As described herein, the content from the IPG generator 110 may be customized for the particular property 112, the particular content provider 108, the particular user, the operator of the server 104, or any combination thereof. The output of the compositer 208 may be a signal that enables viewing of combined content (i.e., IPG content) that shows both the live content from provider 108 as a VIW and the content derived from the database 118 surrounding the VIW, with each type of content being located in a portion of the display as specified by the selected IPG template. An example of the layout for IPG content displayed at a TV on a property 112 is shown in FIG. 4.

The encoder 212 includes hardware and software for encoding the combined content from compositer 208 into a format or standard suitable for distribution to users on the property such as h.264, MPEG2, etc. The packetizer 216 may form packets or other suitable blocks of audio/video data from the encoded signal to yield an IP signal for output to the optional encryptor 220 which may encrypt the IP signal according to an acceptable standard for hospitality environments, such as Pro:Idiom. The content processor 111 outputs the fully-processed and ready-to-be rendered IPG content to the distribution (RF or IP) network of the property 112.

FIGS. 3A-3C illustrate various environments for the system in FIG. 1 where the IPG server 104 is implemented with a cloud architecture that serves multiple properties 112, at least some of which require their own look and feel for IPG content due to branding or other preferences. FIG. 3A illustrates a scenario with an internal RF network that uses two-way coaxial transmission lines 308 to deliver IPG content and to communicate command/control signals for TVs 312 (e.g., RF TVs or TVs with RF-capable STBs), FIG. 3B illustrates an example with an internal IP network that uses Ethernet or another suitable type of transmission lines and switches 316 (e.g., Ethernet switches) to deliver IPG content and to communicate command/control signals for TVs 312 (e.g., IPTVs, or TVs with IP-capable STBs), and FIG. 3C illustrates an example of an internal network that uses a combination of the same switches in FIG. 3B as well as one or more Wi-Fi access points (AP) to deliver the IPG content and to communicate command/control signals for TVs 312 that have built-in Wi-Fi capabilities (i.e., Wi-Fi TV) or that have connected Wi-Fi terminals.

The IPG server 104 in FIGS. 3A-3C may include substantially the same or similar elements as the IPG server 104 in FIGS. 2A and 2B with the following notable differences related to content processor 111a and edge device(s) 304: 1) the content processor 111a in FIGS. 3A-3C may output IPG content with the same or similar low latency format or standard used by the content provider 108 (HLS, MPEG-DASH, CMAF, LL-HLS, WebRTC, SRT, etc.), and thus, the content processor 111 in FIGS. 2A and 2B are reconfigured accordingly; and 2) the property 112 in FIGS. 3A to 3C includes edge device(s) 304 to format the IPG content for distribution to the property and to handle command/control data.

It should be appreciated that the content processor 111a has the same components as the content processor 111 in FIGS. 2A and 2B except that to achieve difference 1), the encoder, packetizer, and encryptor blocks may be reconfigured for content processor 111a. In particular, for content processor 211a, the encoder 212, the packetizer 216, and the encryptor 220 may encode, encapsulate and encrypt the IPG content output from the compositer 208 according to a protocol or standard associated with HLS, MPEG-DASH, CMAF, LL-HLS, WebRTC, SRT, etc., to enable low-latency transmission of the IPG content from the cloud server 104 to the property 112.

In order to achieve difference 2) above, the property 112 includes format converters, embodied as edge device(s) 304, to handle IPG content from the server 104 and to handle command and control data which control functions at the TV based on user input to a remote control of the TV as described above with reference to FIGS. 2A and 2B. In more detail, edge device(s) 304 may include a first edge device 304a comprising a transcoder to decode/encode incoming and outgoing signals and/or transcrypter to decrypt and encrypt incoming and/or outgoing signals. For example, the transcoder/transcrypter 304a may decode and decrypt the encoded and encrypted IPG content received from the server 104 and then reencode and (optionally reencrypt) the IPG content for distribution over the property’s 112 network. In one example, the transcoder/transcrypter converts an incoming HLS signal with IPG content into an h.264 compliant QAM or IP signal having the IPG content formatted for sending to the TV(s) 312. A second edge device 304b may include a command router, such as an interactive TV (ITV) connector or gateway to interpret (e.g., reformat) and route command and control signals between the TVs 312 and the server 104 in the same or similar manner as described above with respect to the command/control data in FIGS. 2A and 2B.

In operation, the cloud server 104 in FIGS. 3A-3C may receive requests for IPG content from users located within properties 112 and respond to the requests with appropriate IPG content. In this way, the cloud server 104 serves tenants which correspond to properties 112. Accordingly, a request for an IPG from a user at a property 112 may be intercepted by edge device(s) 304 at the property to add information to the request which enables the cloud server 104 to generate appropriate IPG content. Such information may include information that specifically identifies the property 112, such as an address of the property 112 (mailing address, IP address, etc.), name of the operator of the property 112 (e.g., HYATT), a randomly-generated number, unique number, or semi-unique matched to the property 112, and/or the like. The request for an IPG from a particular user within the property 112 may include information to identify the user such as loyalty information or other user-specific information that may be used to determine what type of content should be made available to the user.

As may be appreciated from the description of FIGS. 3A-3C, example embodiments provide for remote IPG content rendering, thus removing the need for local resources to render the IPG content, while still enabling the IPG content to be distributed in a format amenable to commercial properties (e.g., through transcoding and/or transcrypting). Distribution of IPG content at the property may then be controlled by edge device(s) 304 that adapt received IPG content for distribution over the property’s preferred infrastructure, such as wired ethernet, wireless ethernet, and/or RF network. In addition and if desired, the edge device(s) 304 may also perform transcryption to remove the (consumer) encryption protocol of the IPG content received by the edge device and add an encryption protocol (commercial) maintaining content protection. Advantages and problems solved include eliminating the need to host an IPG base menu at each property and eliminating the need to host IPG program data at each destination property. In addition, IPG content is enabled without the need for having a separate SmartTV or set top box (STB) in each room of the property. Still further, example embodiments may provide low latency IPG content to commercial environments that utilize either IP or RF signal distribution systems, thus maintaining the user experience associated with hosting the IPG content at the property. Even further, cloud-hosting IPG services enables the option for tailoring of IPG graphical experiences to match preferences for a site, property group, brand, property area (guestroom, lobby, etc.), hotel room, and/or the like without distribution of custom assets to specific physical locations.

FIG. 4 illustrates an example layout 400 for IPG content to be displayed on a TV within a property 112. As described herein, the layout 400 shown in FIG. 4 may correspond to an IPG template selected and then populated by the server 104 with information from the database 118.

In the illustrated example, the “live” or streamed feed from the content provider 108 is included in the VIW portion of the template or layout, which is a resized version of the original stream that transitions from occupying the entire or nearly the entire display of destination device to occupying a portion of the display, in this case, the upper lefthand corner of the display. The layout 400 includes a program guide at the bottom of the display and in an arrangement and style that may be selected according to CMS data from the database 118. The video in the VIW may correspond to video from a currently tuned channel in the program guide, and a user’s selection of the VIW may return the live feed to a state of occupying the entire display, thus exiting the IPG content and causing the server 104 to pause or cease generating the IPG content. Meanwhile, a user’s selection of a different channel in the illustrated program guide (via a remote control) may cause, by iterating through the same steps that generated by initial IPG content, the VIW to switch to the different channel thus enabling the user to view the new channel without exiting the IPG menu. In other examples, selection of a new channel from the program guide exits the IPG content so that video of the new channel occupies the entire display.

FIG. 4 further illustrates how the layout 400 may include ads or fields that lead to ads if selected by the user, such as an advertisement from the content (channel) provider 108, an advertisement from the property 112, an advertisement from the operator of the property entertainment distribution system, and/or the like. Such an advertisement may appear in the upper right hand corner of the display. Additional ad content, such as feature content may also be displayed as shown. Such additional ad content may include one of the ads already mentioned or a prompt for the user to investigate potential services at the property, such as room service, luxury treatments, concierge offerings, etc. In any event, a user’s selection of one of the ad icons in layout 400 may prompt the server 104 to generate content for the selected ad icon and transition at least part of or the entire display to the content for the ad icon which may provide more detail about the ad or potential service. In some examples, the content for the selected ad icon occupies the same window that was selected by the user while the remainder of the displayed IPG content remains the same.

As may be appreciated, more or fewer ad spots may be included in a layout depending on property and/or content provider preferences. In addition, the illustrated windows may take on different sizes, shapes, and/or positions within a display based on the IPG template selected by the server 104.

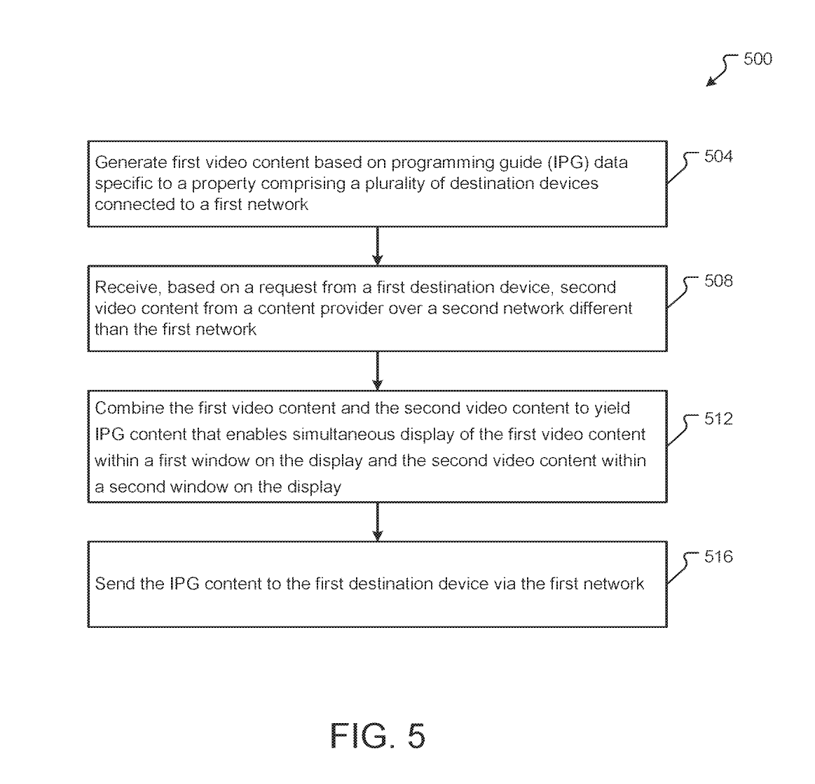

FIG. 5 illustrates a method 500 for providing IPG content to destination devices according to at least one example embodiment. The method 500 may be performed by one or more elements described with reference to FIGS. 1-4.

Step 504 includes generating first video content based on programming guide data specific to a property 112 comprising a plurality of destination devices connected to a first network. The plurality of destination devices may include one or more of a smart TV (IPTV), a combination STB/TV, a combination TV/terminal (B-LAN terminal), an in-room tablet, a personal electronic device (smartphone, laptop, tablet), and/or the like. The programming guide specific data to the property 112 may include any combination of information from the database 118 that controls the look, feel, and ad content of the IPG content based on look, feel, and ad preferences controlled by the property 112, the content provider 108, and/or the operator of the property’s entertainment system. The first video content may be generated responsive to a request received by the server 104 as command data triggered by a user’s input to a controller of a destination device, such as the user’s press of a “Guide” button on a remote control of a TV. Step 504 may be performed by the IPG generator 110 described herein such that the eventual IPG content comprises first content having a look and feel that is controlled by the content provider 108, second content having a look and feel that is controlled by the property 112, and third content having a look and feel that is controlled by an operator of the server 104 and/or entertainment system at the property 112.

Step 508 includes receiving second video content from a content provider 108 over a second network different than the first network. Receiving the second video content in step 508 may be responsive to a request from the first destination device for a “live” feed of audio/video content, such as a request generated by input to the user’s remote control to view a particular channel at a TV. The request for the second video content may occur earlier in time than the request for the first video content in that the user may already be viewing the second video content from the content provider when the request for IPG content in step 504 is initiated. In any event, the first network may be internal to the property 112 and the second network may be external to the property. In some examples, the first network is generally isolated from the second network in that an entity, such as the property 112, can exert control over the first network (but not the second network) by controlling or at least modifying communications between the first network and the second network. In some examples, the first network comprises a radio frequency network and the second network comprises an Internet Protocol (IP) network. In other examples, the first network comprises a first IP network and the second network comprises a second IP network.

Step 512 includes combining the first video content and the second video content to yield IPG content that enables simultaneous display of the first video content within a first window on the display and the second video content within a second window on the display. Step 512 may be performed by content processor 111 or 111a and its various components shown and described with reference to FIGS. 1-4. In some examples, step 512 includes decoding the second video content, for example, as does the decoder/decrypter 204, combining the decoded second video content with the first video content to yield intermediate content via the compositer 208, and then encoding the intermediate content to yield the IPG content using the encoder 212. As described herein, the intermediate content is encoded according to a standard used for transmission of the IPG content over a network, whether it be the first network internal to the property (encoded according to h.264, MPEG2, etc.) or the second network external to the property (encoded according to HLS, DASH, etc.). In some examples, the method 500 includes encrypting the IPG content for transmission, whether over the first network or the second network.

Step 516 includes sending the IPG content to the first destination device via the first network. For example, if the server 104 is a local server, the server 104 outputs the IPG content directly to the first network for distribution to the first destination device. If the server 104 is a cloud server, the server 104 outputs the IPG content to the second network for delivery to the property 112 which distributes the IPG content over the first network to the first destination device. In some examples, step 516 includes converting the IPG content from one format to another to enable transmission over the first network. For example, step 516 converts the IPG content from a format suitable for transmission over the second network to a format suitable for transmission over the first network, through for example, a format converter such as an edge device 204 or 304.

Although not explicitly shown, it should be appreciated that for cloud implementations of the server 104, the method 500 may further include generating additional IPG content for each of a plurality of properties 112 based on respective programming guide data for each of the plurality of properties and then sending the additional IPG content to each property 112. Generating and sending the additional IPG content may be accomplished by iterating through the method 500 for each property 112 from which a request for IPG content is received.

Additionally, in some examples, the method 500 includes interpreting and routing commands and control signals between destination devices of a property 112 and a content provider 108 and/or server 104. Such commands may correspond to user commands input to a remote control of a TV to, for example, change the channel, request IPG content, navigate menus, etc. while the control signals correspond to responses from the server 104 and/or the content provider 108 which cause the TV to perform a function corresponding to the command change channel, update menus to reflect user navigation, etc.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
a processor; and
memory including instructions, which when executed by the processor, cause the processor to:
generate, based on a request from a first destination device, first video content based on programming guide data specific to a property comprising a plurality of destination devices connected to a first network;
receive second video content from a content provider over a second network different than the first network;
combine the first video content and the second video content to yield IPG content that enables simultaneous display of the first video content within a first window on a display and the second video content within a second window on the display; and
send the IPG content to the first destination device via the first network.

2. The system of claim 1, wherein the first network is internal to the property and the second network is external to the property.

3. The system of claim 2, wherein the first network comprises a radio frequency network and the second network comprises an Internet Protocol (IP) network.

4. The system of claim 2, wherein the first network comprises a first IP network and the second network comprises a second IP network.

5. The system of claim 1, further comprising:
a format converter to convert the IPG content from a format for transmission over the second network to a format for transmission over the first network.

6. The system of claim 5, further comprising:
a command router to interpret and route commands between the plurality of destination devices and the content provider.

7. The system of claim 1, wherein the IPG content comprises first content having a look and feel that is controlled by the content provider.

8. The system of claim 7, wherein the IPG content comprises second content having a look and feel that is controlled by the property.

9. The system of claim 1, wherein the server is cloud-based and the memory includes instructions, which when executed by the processor, cause the processor to:
generate additional IPG content for each of a plurality of properties based on respective programming guide data for each of the plurality of properties; and
send the additional IPG content to each property.

10. The system of claim 9, wherein the additional IPG content for each property comprises first content having a look and feel that is controlled by that property.

11. The system of claim 10, wherein the additional IPG content comprises second content having a look and feel that is controlled by the content provider.

12. The system of claim 1, further comprising:
the plurality of destination devices.

13. A device, comprising:
a program guide generator to generate, based on a request from a first destination device, first video content based on programming guide data specific to a property comprising a plurality of destination devices connected to a first network; and
a content processor to:
receive second video content from a content provider over a second network different than the first network;
combine the first video content and the second video content to yield IPG content that enables simultaneous display of the second video content within a first window on a display and the first content within a second window on the display; and
send the IPG content to the first destination device via the first network.

14. The device of claim 13, wherein the IPG content comprises first content having a look and feel that is controlled by the content provider.

15. The device of claim 14, wherein the IPG content comprises second content having a look and feel that is controlled by the property.

16. The device of claim 13, wherein combining the first video content and the second video content includes:
decoding the second video content;
combining the decoded second video content with the first video content to yield intermediate content; and
encoding the intermediate content to yield the IPG content.

17. The device of claim 16, wherein the intermediate content is encoded according to a standard used for transmission of the IPG content over the first network.

18. The device of claim 16, wherein the content processor is to encrypt the IPG content for transmission over the first network.

19. The device of claim 16, further comprising:
a format converter to convert the IPG content from a format for transmission over the second network to a format for transmission over the first network.

20. A method, comprising:
generating, based on a request from a first destination device, programming guide content based on programming guide data specific to a property comprising a plurality of destination devices connected to a first network;
receiving video content from a content provider over a second network different than the first network;
combining the first programming guide content and the video content to yield IPG content that enables simultaneous display of the video content within a first window on a display and the programming guide content within a second window on the display; and
sending the IPG content to the first destination device via the first network.
